(19) United States
(12) Patent Application Publication
(10) Pub. No.: US 2023/0338957 A1
(43) Pub. Date: Oct. 26, 2023

(54) REACTION WELL CARTRIDGE DEVICE AND REACTION WELL CARTRIDGE SYSTEM

(71) Applicant: MICRO DIGITAL CO., LTD, Seongnam-si, Gyeonggi-do (KR)

(72) Inventor: Kyung Nam KIM, Gwangju-si, Gyeonggi-do (KR)

(21) Appl. No.: 18/033,784

(22) PCT Filed: Oct. 7, 2021
(86) PCT No.: PCT/KR2021/013777

§ 371 Date: Apr. 25, 2023

(30) Foreign Application Priority Data
Nov. 23, 2020 (KR) 10-2020-0158193

(51) Int. Cl. B01L 3/00

(52) U.S. Cl. CPC B01L 3/508; B01L 2200/16; B01L 2300/069

(57) ABSTRACT

Provided is a reaction well cartridge device and a reaction well cartridge system. The reaction well cartridge device may include a cartridge body in which a reaction well container for accommodating reaction wells, wherein the cartridge body includes one or more of a dispensing tip container, a sample container for accommodating samples, a reagent container for accommodating reagents, a mixture container for accommodating a mixture containing the samples and the reagents, a diluent container for accommodating a diluent, a washing solution container for accommodating a washing solution, and combinations thereof; a temporary storage formed in the cartridge body and configured to temporarily store waste generated after reaction in the reaction wells; and a non-return valve device installed in a waste passage formed on one side of the temporary storage to prevent inflow of the waste from flowing backwards.

### TECHNICAL FIELD

The present invention relates to a reaction well cartridge device and a reaction well cartridge system, and more particularly, to a reaction well cartridge device and a reaction well cartridge system that facilitate a biochemical or biological reaction.

### BACKGROUND ART

In recent years, various chemiluminescence (CL) methods have been developed. Examples of the chemiluminescence (CL) methods include an enzyme immunoassay (ELIA) using an antigen-antibody reaction, a chemiluminescence immunoassay (CLIA) in which a chemiluminescent compound is used for labeling as a tracer for immunoassay, and a chemiluminescent enzyme immunoassay (CLEIA) that detects enzyme activity with high sensitivity using a chemiluminescent compound in a detection system.

In these immunoassays, the presence and concentration of an analyte are confirmed through the selective reaction of an antigen and an antibody. In this process, substances that do not selectively react are removed through washing before signal measurement.

By reducing background signals through this washing process, the sensitivity of a signal may be increased.

Capillary-driven flow using capillary force uses a phenomenon in which fluid flows automatically by surface tension without an external pump. Various simple disposable immunoassay products, such as pregnancy diagnostic reagents, have been developed using this capillary-driven flow. Most of these products use porous materials to induce capillary-driven flow, and washing cannot be performed more than once.

In addition, according to U.S. Pat. No. 6271040, capillary-driven flow is generated in a microchannel without using a porous material. However, although the product and patent use capillary force, only one sample solution causes microfluidic washing. It is difficult to remove background signals caused by the sample.

As described above, technology development for effective washing is still insufficient, and there are many things to be improved. Accordingly, it is required to develop technology that enables washing using fluid control within a reaction well, easy manufacture of a cartridge, and quick and simple repeated washing.

In addition, after completion of a test, a mixture containing used samples, reagents, and washing solutions is discharged through a separate waste transport line. Waste discharged from multiple reaction wells is collected in a waste storage tank and stored in a large capacity. Then, when the waste storage tank is full, the waste is discarded.

However, a large-capacity waste storage tank that accommodates a large amount of waste is repulsive in appearance. In addition, waste that has undergone reactions in multiple reaction wells are already contaminated or may be easily contaminated by various viruses or bacteria. Accordingly, bacterial growth or decomposition rapidly progresses over time, and the waste collection tube, the waste storage tank, or surrounding environments may be extensively contaminated.

### DISCLOSURE

### Technical Problem

Therefore, the present invention has been made in view of the above problems, and it is one object of the present invention to provide a reaction well cartridge device and a reaction well cartridge system being capable of easily performing fluid control for biochemical reactions in reaction wells; having the advantage of easy manufacturing; being capable of controlling fluid flow, stop, and washing using an active pump; being capable of controlling the number of washing; having excellent appearance by temporarily storing waste inside a cartridge to be discarded after using for one-time use; being capable of preventing bacterial growth, spoilage, or external leakage of waste; being capable of improving the safety of biopsy; being capable of preventing environmental pollution in advance; and enabling smooth flow of waste by preventing backflow of waste and accumulation of internal air. However, this purpose is illustrative, and the scope of the present invention is not limited thereto.

### Technical Solution

In accordance with one aspect of the present invention, provided is a reaction well cartridge device including a cartridge body in which a reaction well container for accommodating reaction wells in which biological reactions occur is formed, wherein the cartridge body includes one or more of a dispensing tip container for accommodating dispensing tips, a sample container for accommodating samples, a reagent container for accommodating reagents, a mixture container for accommodating a mixture containing the samples and the reagents, a diluent container for accommodating a diluent, a washing solution container for accommodating a washing solution, and combinations thereof; a temporary storage formed in the cartridge body and configured to temporarily store waste generated after reaction in the reaction wells; and a non-return valve device installed in a waste passage formed on one side of the temporary storage to prevent inflow of the waste from flowing backwards.

In addition, according to the present invention, a valve having an X-shaped cutout may be installed in the non-return valve device.

In addition, according to the present invention, the reaction well cartridge device of the present invention may further include an air exhaust installed on the other side of the temporary storage, positioned above the non-return valve device, and configured to discharge internal air to the outside to reduce internal air pressure increased according to inflow of the waste.

In addition, according to the present invention, the temporary storage may include a waste storage case having an accommodation space formed therein; and a waste absorber accommodated in the accommodation space and capable of absorbing the waste to prevent leakage of the waste to the outside.

In addition, according to the present invention, the waste absorber may be a compression-type dry sponge capable of absorbing the waste while expanding.

In addition, according to the present invention, the waste absorber may include a coagulant that solidifies when mixed with moisture to prevent leakage of the waste to the outside and environmental pollution caused by the waste.

In addition, according to the present invention, the waste absorber may include one or more of a disinfectant, a germicide, a deodorant, a preservative, a bleach, a fragrance, a coagulant, and combinations thereof.

In addition, according to the present invention, the temporary storage may be formed below a portion including one or more of the sample container, the reagent container, the mixture container, the diluent container, the washing solution container, and combinations thereof.

In addition, according to the present invention, the temporary storage may be formed below the reaction well container to be indirectly or directly connected to the reaction wells.

In accordance with another aspect of the present invention, provided is a reaction well cartridge system including a reaction well cartridge device including a cartridge body in which a reaction well container for accommodating reaction wells in which biological reactions occur is formed, wherein the cartridge body includes one or more of a dispensing tip container for accommodating dispensing tips, a sample container for accommodating samples, a reagent container for accommodating reagents, a mixture container for accommodating a mixture containing the samples and the reagents, a diluent container for accommodating a diluent, a washing solution container for accommodating a washing solution, and combinations thereof; a temporary storage formed in the cartridge body and configured to temporarily store waste generated after reaction in the reaction wells; and a non-return valve device installed in a waste passage formed on one side of the temporary storage to prevent inflow of the waste from flowing backwards, and a waste transfer device for transferring the waste from the reaction wells to the temporary storage.

In addition, according to the present invention, the waste transfer device may include a first transfer line extending from the reaction wells to the temporary storage; a first valve installed on the first transfer line; and a first pump installed in the first transfer line.

### Advantageous Effects

According to embodiments of the present invention, the present invention has an effect of providing a reaction well cartridge device and a reaction well cartridge system being capable of easily performing fluid control for biochemical reactions in reaction wells; having the advantage of easy manufacturing; being capable of controlling fluid flow, stop, and washing using an active pump; being capable of controlling the number of washing; having excellent appearance by temporarily storing waste inside a cartridge to be discarded after using for one-time use; being capable of preventing bacterial growth, spoilage, or external leakage of waste; being capable of improving the safety of biopsy; being capable of preventing environmental pollution in advance; and enabling smooth flow of waste by preventing backflow of waste and accumulation of internal air. However, the scope of the present invention is not limited by this effect.

### DESCRIPTION OF DRAWINGS

FIG. 1 is a perspective view showing the appearance of a reaction well cartridge device according to an embodiment of the present invention.

FIG. 2 is a side view of the reaction well cartridge device of FIG. 1.

FIG. 3 is a cross-sectional view of the reaction well cartridge device of FIG. 1 and a reaction well cartridge system.

FIG. 4 is an image of the reaction well cartridge device of FIG. 1.

FIG. 5 is a perspective view showing the appearance of a reaction well cartridge device according to another embodiment of the present invention.

FIG. 6 is a side view of the reaction well cartridge device of FIG. 5.

FIG. 7 is a cross-sectional view of the reaction well cartridge device of FIG. 5 and a reaction well cartridge system.

FIG. 8 is an image of the reaction well cartridge device of FIG. 5.

### BEST MODE

Hereinafter, the present invention will be described in detail by explaining exemplary embodiments of the invention with reference to the attached drawings.

These embodiments are provided to more fully describe the present invention to those skilled in the art. The following embodiments may be modified in many different forms, and the scope of the present invention is not limited to the following embodiments. Rather, these embodiments are provided so that this disclosure will be thorough and complete, and will fully convey the spirit of the invention to those skilled in the art. In addition, the thickness or size of each layer in the drawings is exaggerated for convenience and clarity of explanation.

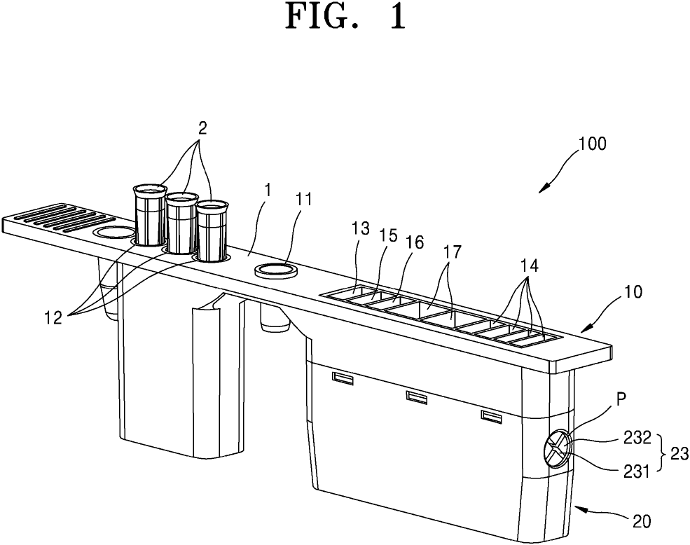

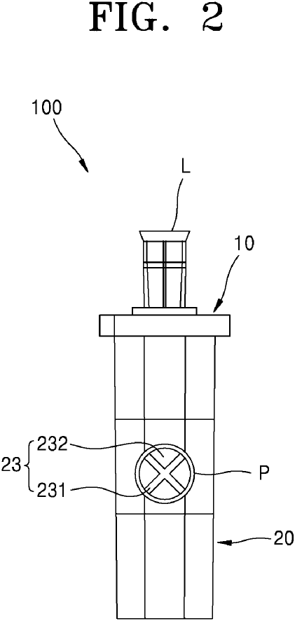

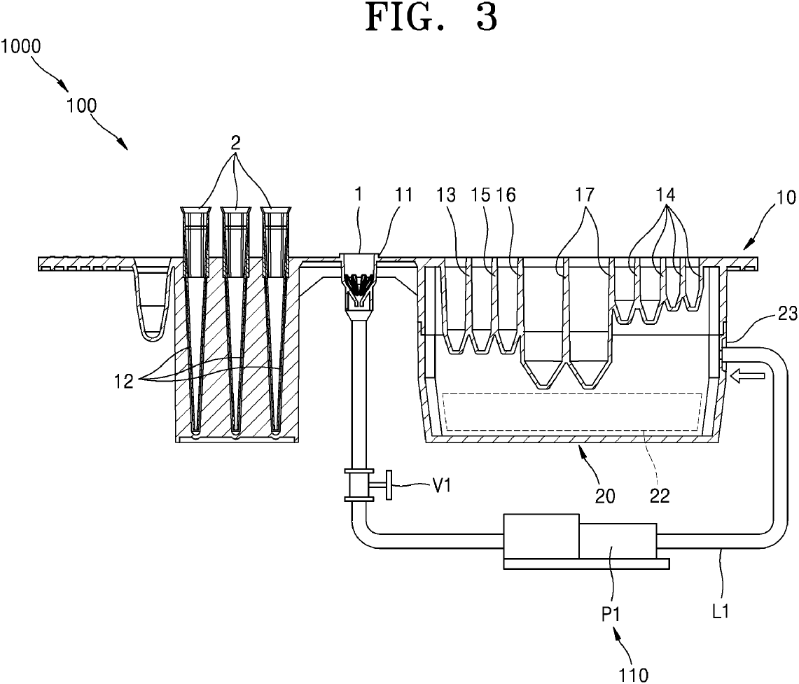

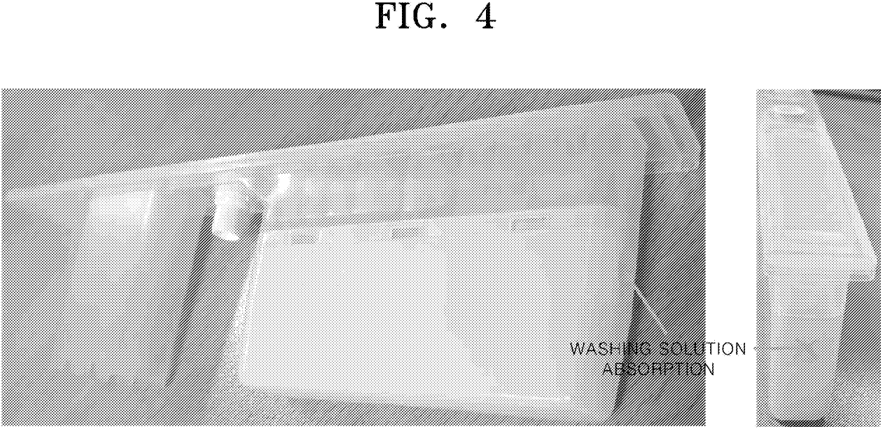

FIG. 1 is a perspective view showing the appearance of a reaction well cartridge device 100 according to an embodiment of the present invention, FIG. 2 is a side view of the reaction well cartridge device 100 of FIG. 1, FIG. 3 is a cross-sectional view of the reaction well cartridge device 100 of FIG. 1 and a reaction well cartridge system 1000, and FIG. 4 is an image of the reaction well cartridge device 100 of FIG. 1.

First, as shown in FIGS. 1 to 4, the reaction well cartridge device 100 according to an embodiment of the present invention may include a cartridge body 10 and a temporary storage 20.

For example, as shown in FIGS. 1 to 5, a reaction well container 11 for accommodating reaction wells 1 in which biological reactions occur may be formed in the cartridge body 10. The cartridge body 10 may be a multi-container type part formed of a resin material, and may include one or more of a dispensing tip container 12 for accommodating dispensing tips 2, a sample container 13 for accommodating a sample, a reagent container 14 for accommodating a reagent, a mixture container 15 for accommodating a mixture containing the sample and the reagent, a diluent container 16 for accommodating a diluent, a washing solution container 17 for accommodating a washing solution, and a combination thereof.

In addition, for example, as shown in FIGS. 1 to 4, the temporary storage 20 may be assembled and mounted on the cartridge body 10, or integrally formed with the cartridge body 10. The temporary storage 20 may be a separate container-type part for temporarily storing waste generated after reaction in the reaction wells 1.

As a more specific example, as shown in FIGS. 1 to 4, the temporary storage 20 may include a waste storage case 21 having an accommodation space formed therein and a waste absorber 22 accommodated in the accommodation space and capable of absorbing the waste to prevent leakage of the waste to the outside.

For example, the waste absorber 22 may be a compression-type dry sponge capable of absorbing the waste while expanding using capillarity. However, the present invention is not limited thereto, and all types of porous materials capable of absorbing the waste may be used. Accordingly, once the waste is absorbed by the waste absorber 22, the absorbed waste may be safely stored in the internal space without leakage to the outside.

In addition, for example, to prevent leakage of the waste to the outside and environmental pollution caused by the waste, the waste absorber 22 may include a coagulant that solidifies into a gel when mixed with moisture. That is, the waste absorbed by the waste absorber 22 may be solidified and prevented from escaping to the outside, and bacterial propagation or decay may be prevented due to moisture reduction.

In addition, the waste absorber 22 may include one or more of a disinfectant, a germicide, a deodorant, a preservative, a bleach, a fragrance, a coagulant, and combinations thereof.

Accordingly, bacterial propagation in the waste absorbed by the waste absorber 22 or corruption of the waste may be prevented by action of the aforementioned various chemicals. In addition, generation of various odors, discoloration, or contamination may be prevented.

In addition, for example, as shown in FIGS. 1 to 4, the reaction well cartridge device 100 according to an embodiment of the present invention may further include a non-return valve device 23 installed in a waste passage (P) formed on one side of the temporary storage 20 to prevent inflow of the waste from flowing backward.

As a more specific example, a valve 232 having an X-shaped cutout 231 may be installed in the non-return valve device 23.

However, the shape or type of the cutout 231 or the valve 232 is not limited to the drawings. Various types of valves, such as a valve having a half-moon-shaped cutout formed on the lower or upper portion thereof and a value having a straight cutout formed in the center thereof, may be used.

Accordingly, for example, by using the non-return valve device 23 in which the valve 232 is installed, leakage of the waste to the outside may be fundamentally prevented.

In addition, as shown in FIGS. 1 to 4, the temporary storage 20 may be formed below a portion including one or more of the sample container 13, the reagent container 14, the mixture container 15, the diluent container 16, the washing solution container 17, and combinations thereof.

Accordingly, since the temporary storage 20 is separated from the reaction wells 1, adverse effects on the reaction wells 1 due to the waste during a reaction process in the reaction wells 1 may be fundamentally prevented.

Accordingly, since the waste is temporarily stored inside the reaction well cartridge device to be used for single use and discarded, an excellent appearance may be achieved. In addition, bacterial growth, decay, or leakage of waste to the outside may be prevented, thereby improving hygiene. As a result, safety of bio-inspection may be improved, and environmental contamination may be prevented in advance.

In addition, as shown in FIG. 3, the reaction well cartridge system 1000 according to an embodiment of the present invention may include the reaction well cartridge device 100 described above and a waste transfer device 110 for transferring the waste from the reaction wells 1 to the temporary storage 20.

As shown in FIG. 3, the waste transfer device 110 may include a first transfer line L1 extending from the reaction wells 1 to the temporary storage 20, a first valve V1 installed on the first transfer line L1, and a first pump P1 installed in the first transfer line L1.

An electronic valve, such as a solenoid valve, or a mechanical valve may be used as the first valve V1. A variety of non-contact or contact pumps such as diaphragm-type pumps and diffusion-type pumps may be used as the first pump P1.

Accordingly, for example, after reaction in the reaction wells 1 is completed, when the first pump P1 is operated or the first valve V1 is opened, the waste is transferred from the reaction wells 1 to the temporary storage 20 along the first transfer line L1 and temporarily stored in the temporary storage 20. Then, the waste may be disposed together with the cartridge body 10 separately.

Here, as an example of reaction occurring in the reaction wells 1, an example of selecting, using an IL-6 antibody, a binding inducer capable of adsorption or biospecific binding in the reaction wells 1 and immobilizing the binding inducer on the surface will be described below. For example, an immobilization reaction may be performed on the surface for 30 minutes using 1 % glutaraldehyde diluted in 0.1 M MES (pH 6.1) and 30 µl of a sample solution.

Subsequently, washing may be performed once for 10 minutes using 30 µl of a washing solution consisting of 0.1 M MES (pH 6.1). 30 µl of the IL-6 antibody at a concentration of 10 µg/mL is added, and reaction between glutaraldehyde and the IL-6 antibody may be induced for 30 minutes.

Then, a sample solution containing 2 % BSA and 0.05 % Triton X-100-0.1 M Tris (pH7.6) may be added, and reaction may be performed twice for 10 minutes to remove the unbound functional groups of glutaraldehyde from the surface in the reaction wells 100.

Subsequently, 30 µl of an IL-6 antigen is added for each concentration to be analyzed, and binding with the antibody is allowed to occur for 30 minutes. 30 µl of a washing solution consisting of 0.05 % Triton X-100-Tris (pH 7.6) may be added, and washing may be performed once for 10 minutes.

Subsequently, 30 µl of an antibody-biotin polymer at a concentration of 2 µg/mL may be added, and biospecific binding may be induced for 30 minutes. Again, 30 µl of the washing solution consisting of 0.05 % Triton X-100-Tris (pH 7.6) may be added, and washing may be performed once for 10 minutes.

Then, 30 µl of a streptavidin-enzyme (streptavidin-HRP) polymer may be added, and biospecific binding between the antibody-biotin polymer and the streptavidin-enzyme polymer may be allowed to occur for 30 minutes.

Subsequently, 30 µl of the washing solution consisting of 0.05 % Triton X-100-Tris (pH 7.6) may be added, and washing may be performed three times at 10-minute intervals to remove unbound streptavidin-enzyme.

Finally, 30 µl of an enzyme-reactive substrate may be added and allowed to react for 15 minutes. Then, the amount of the IL-6 antigen may be quantified. At this time, an analysis method such as absorption, fluorescence, or chemiluminescence may be selected according to the type of the enzyme-reactive substrate.

Accordingly, by reducing background signals generated in an immunoassay process by repeatedly performing washing one or more times inside the reaction wells 1 of the present invention, signal sensitivity may be increased, and simplification of an analysis device may be implemented. In addition, the device of the present invention may be applied to a microchip-based analysis device that requires washing to remove residual substances (antigens, antibodies, probes, etc.) unavoidably generated in biological reactions. For example, the device of the present invention may be usefully used in sandwich-type immunoassays and nucleic acid detection methods. In addition, in the case of the device of the present invention, washing may be performed quickly and simply by the active pump, and biochemical analysis may be performed without an additional suction process for removing the washing solution during the washing process.

In addition, waste generated in this process may be temporarily stored in the temporary storage 20 and then separately discarded together with the cartridge body 10.

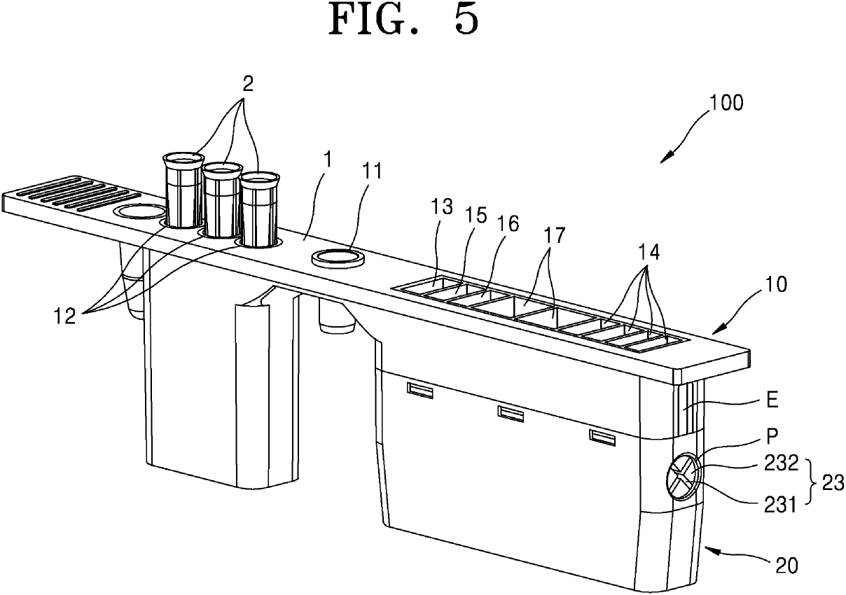

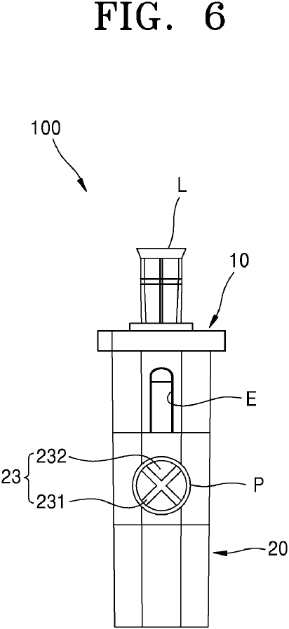

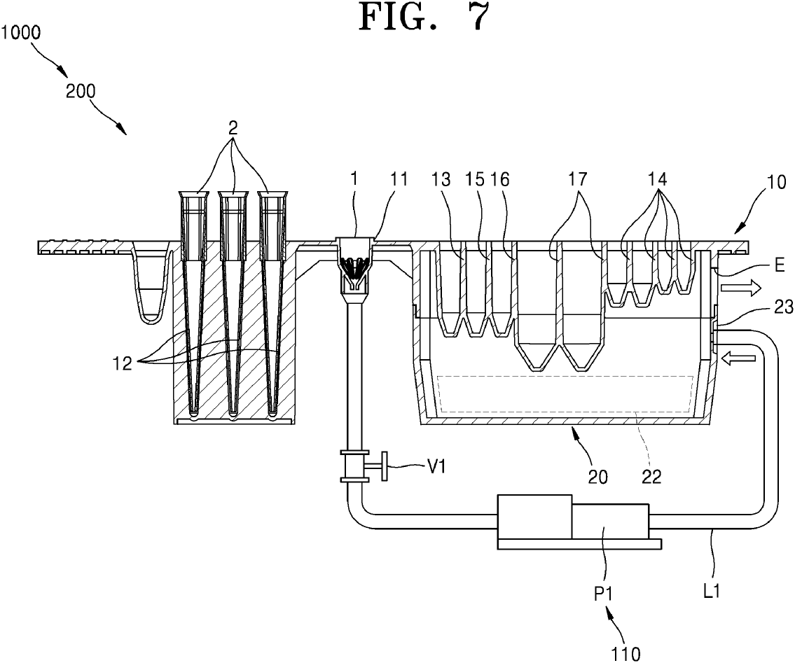

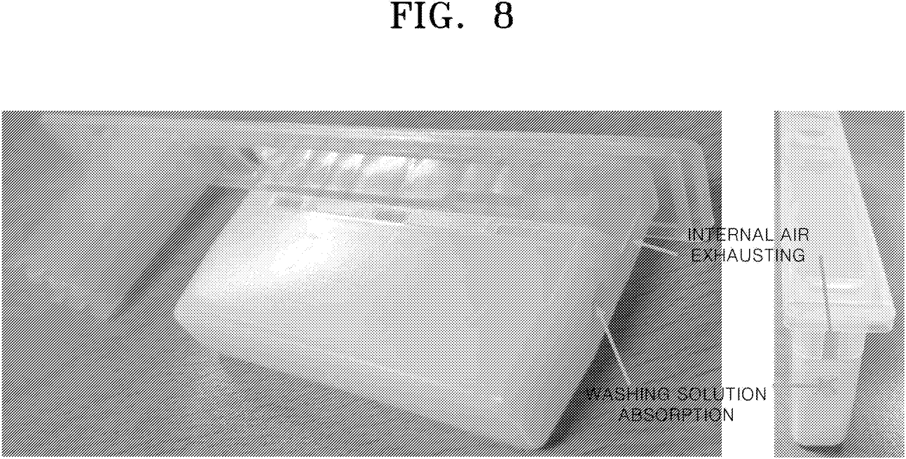

FIG. 5 is a perspective view showing the appearance of a reaction well cartridge device 200 according to another embodiment of the present invention, FIG. 6 is a side view of the reaction well cartridge device 200 of FIG. 5, FIG. 7 is a cross-sectional view of the reaction well cartridge device 200 of FIG. 5 and a reaction well cartridge system 100, and FIG. 8 is an image of the reaction well cartridge device of FIG. 5.

As shown in FIGS. 5 to 8, the reaction well cartridge device 200 according to another embodiment of the present invention may further include an air exhaust (E) installed on the other side of the temporary storage 20, positioned above the non-return valve device 23, and configured to discharge internal air to the outside to reduce internal air pressure increased according to inflow of the waste.

The air exhaust (E) may be an outlet elongated in the vertical direction to widen an air discharge area.

However, the shape of the air exhaust (E) is not limited to the drawings. A plurality of air exhausts may be formed in a very small size, or an air exhaust with a complicated flow path formed therein may be used to prevent outflow of waste. That is, various types of exhausts may be used.

Accordingly, when the waste flows into the temporary storage 20 through the non-return valve device 23, internal air pressure increases. At this time, waste stagnation occurs due to the increased air pressure, so that no more waste flows into the temporary storage 20. At this time, by discharging the internal air to the outside using the air exhaust (E), waste stagnation may be prevented and smooth flow of waste may be induced.

Therefore, fluid control for biochemical reactions may be easily performed in the reaction wells 1, the device may be easily manufactured, and fluid flow, stopping, and washing may be controlled by the active pump, so that residues after washing may be easily recovered. In addition, by preventing reverse flow of waste and accumulation of internal air, smooth flow of waste may be realized.

Although the present invention has been described with reference to the embodiments shown in the drawings, this is merely exemplary, and those skilled in the art will understand that various modifications and equivalent other embodiments are possible therefrom. Therefore, the true technical protection scope of the present invention should be determined by the technical spirit of the appended claims.

1] A reaction well cartridge device, comprising:
a cartridge body in which a reaction well container for accommodating reaction wells in which biological reactions occur is formed, wherein the cartridge body comprises one or more of a dispensing tip container for accommodating dispensing tips, a sample container for accommodating samples, a reagent container for accommodating reagents, a mixture container for accommodating a mixture containing the samples and the reagents, a diluent container for accommodating a diluent, a washing solution container for accommodating a washing solution, and combinations thereof;
a temporary storage formed in the cartridge body and configured to temporarily store waste generated after reaction in the reaction wells; and
a non-return valve device installed in a waste passage formed on one side of the temporary storage to prevent inflow of the waste from flowing backwards.

2] The reaction well cartridge device according to claim 1, wherein a valve having an X-shaped cutout is installed in the non-return valve device.

3] The reaction well cartridge device according to claim 1, further comprising an air exhaust installed on the other side of the temporary storage, positioned above the non-return valve device, and configured to discharge internal air to the outside to reduce internal air pressure increased according to inflow of the waste.

4] The reaction well cartridge device according to claim 1, wherein the temporary storage comprises a waste storage case having an accommodation space formed therein; and a waste absorber accommodated in the accommodation space and capable of absorbing the waste to prevent leakage of the waste to the outside.

5] The reaction well cartridge device according to claim 4, wherein the waste absorber is a compression-type dry sponge capable of absorbing the waste while expanding.

6] The reaction well cartridge device according to claim 4, wherein the waste absorber comprises a coagulant that solidifies when mixed with moisture to prevent leakage of the waste to the outside and environmental pollution caused by the waste.

7] The reaction well cartridge device according to claim 4, wherein the waste absorber comprises one or more of a disinfectant, a germicide, a deodorant, a preservative, a bleach, a fragrance, a coagulant, and combinations thereof.

8] The reaction well cartridge device according to claim 1, wherein the temporary storage is formed below a portion comprising one or more of the sample container, the reagent container, the mixture container, the diluent container, the washing solution container, and combinations thereof.

9] The reaction well cartridge device according to claim 1, wherein the temporary storage is formed below the reaction well container to be indirectly or directly connected to the reaction wells.

10] A reaction well cartridge system, comprising:
a reaction well cartridge device comprising a cartridge body in which a reaction well container for accommodating reaction wells in which biological reactions occur is formed, wherein the cartridge body comprises one or more of a dispensing tip container for accommodating dispensing tips, a sample container for accommodating samples, a reagent container for accommodating reagents, a mixture container for accommodating a mixture containing the samples and the reagents, a diluent container for accommodating a diluent, a washing solution container for accommodating a washing solution, and combinations thereof; a temporary storage formed in the cartridge body and configured to temporarily store waste generated after reaction in the reaction wells; and a non-return valve device installed in a waste passage formed on one side of the temporary storage to prevent inflow of the waste from flowing backwards, and
a waste transfer device for transferring the waste from the reaction wells to the temporary storage.

11] The reaction well cartridge system according to claim 10, wherein the waste transfer device comprises a first transfer line extending from the reaction wells to the temporary storage; a first valve installed on the first transfer line; and a first pump installed in the first transfer line.
